(19) United States
(12) Patent Application Publication
(10) Pub. No.: US 2017/0286440 A1
(43) Pub. Date: Oct. 5, 2017

(54) METHOD, BUSINESS PROCESSING SERVER AND DATA PROCESSING SERVER FOR STORING AND SEARCHING TRANSACTION HISTORY DATA

(71) Applicant: TMAXSOFT. CO., LTD., Gyeonggi-do (KR)

(72) Inventors: Hong Jun Jung, Seoul (KR); Jin Won Lee, Gyeonggi-do (KR); Byong John Han, Gyeonggi-do (KR)

(21) Appl. No.: 15/440,232

(22) Filed: Feb. 23, 2017

(30) Foreign Application Priority Data
Apr. 5, 2016 (KR) 10-2016-0041952

(51) Int. Cl. G06F 17/30

(52) U.S. Cl. CPC G06F 17/30097; G06F 17/30227; G06F 17/30371

(57) ABSTRACT

A method for storing transaction history data is provided. The method includes steps of: (a) a business processing server creating or supporting to create index data regarding a start of a transaction if the transaction starts; (b) the business processing server creating or supporting to create trace data related to processing individual services of the transaction; and (c) the business processing server creating or supporting to create index data regarding an end of the transaction if the transaction ends; wherein the business processing server stores or supports to store the index data regarding the start of the transaction and the index data regarding the end of the transaction in a database and the trace data related to processing the individual services of the transaction in a separate file system.

### CROSS REFERENCE TO RELATED APPLICATION

This application claims priority to and incorporates herein by reference all disclosure in Korean Patent Application No. 10-2016-0041952 filed Apr. 5, 2016.

### FIELD OF THE INVENTION

The present invention relates to a method, a business processing server, and a data processing server for storing and searching transaction history data; and more particularly, to the method, the business processing server, and the data processing server for performing “a process of storing transaction history data” capable of creating or supporting to create index data regarding start of a transaction if the transaction starts, trace data related to processing individual services of the transaction, and index data regarding end of the transaction if the transaction ends and capable of storing or supporting to store the index data regarding the start of the transaction and the index data regarding the end of the transaction in a database and the trace data related to processing the individual services of the transaction in a separate file system, and “a process of searching the transaction history data” capable of searching or supporting to search the index data related to the transaction in the database by using a value of a search key if a search query for the transaction history data is inputted and searching or supporting to search the trace data related to the transaction in the file system by referring to a start time and an end time of the transaction included in the index data.

### BACKGROUND OF THE INVENTION

In general, B2B or B2C services may require transaction history tracking in real time to process a lot of transactions per second and respond rapidly to abnormal transactions. Most applications with regard to data linkage require that all history data be stored in a database for convenience and stability of data search and data storage. However, since an amount of history data generated through data linkages exceeds that of data used for the data linkage, the database may lack in its ability to process data per second. Accordingly, a difference between a point at which an actual transaction occurs and a point at which the transaction history is possible to view may increase.

Therefore, a detection of a problem may be delayed and monetary or time loss may occur because it takes a longer time to respond to a failure.

Accordingly, studies on a technology for rapidly storing and searching large history data created in real time are required. The inventor hereby came to develop large transaction history management architecture capable of minimizing a difference between a point at which an actual transaction occurs and a point at which the transaction history is possible to view.

### SUMMARY OF THE INVENTION

It is an object of the present invention to solve all the aforementioned problems.

It is one object of the present invention to provide a large transaction history management system capable of minimizing a difference between a point at which transaction history data are generated and a point at which the transaction history data are possible to search by effectively storing and managing information on large transaction history.

It is another object of the present invention to provide a large transaction history management system capable of minimizing a difference between a point at which transaction history data are generated and a point at which the transaction history data are possible to search by separately creating, storing and managing history data to be used as index data and history data (i.e., trace data) by point at which an actual transaction occurs.

It is still another object of the present invention to prevent loss of history data by temporarily storing the history data in a storage of a business process server if there is a data transmission failure and then transmitting the history data to a data processing server if the failure is restored.

It is still yet another object of the present invention to provide a large transaction history management system capable of storing and searching information on large transaction history more effectively and rapidly by storing and managing long-term transaction data whose transaction does not end within a specific time from a time at which the transaction starts in a separate file system.

In accordance with one aspect of the present invention, there is provided a method for storing transaction history data, including steps of: (a) a business processing server creating or supporting to create index data regarding a start of a transaction if the transaction starts; (b) the business processing server creating or supporting to create trace data related to processing individual services of the transaction; and (c) the business processing server creating or supporting to create index data regarding an end of the transaction if the transaction ends; wherein the business processing server stores or supports to store the index data regarding the start of the transaction and the index data regarding the end of the transaction in a database and the trace data related to processing the individual services of the transaction in a separate file system.

In accordance with another aspect of the present invention, there is provided a method for searching transaction history data, including steps of: (a) a data processing server searching or supporting to search index data related to a transaction in a database by using a value of a search key if a search query for the transaction history data is inputted; and (b) the data processing server searching or supporting to search trace data related to the transaction in a file system by referring to a start time and an end time of the transaction included in the index data.

In accordance with still another aspect of the present invention, there is provided a business processing server for storing transaction history data, including: a processor for creating or supporting to create index data regarding a start of a transaction if the transaction starts, trace data related to processing individual services of the transaction, and index data regarding an end of the transaction if the transaction ends; and a communication part for storing or supporting to store the index data regarding the start of the transaction and the index data regarding the end of the transaction in a database and the trace data related to processing the individual services of the transaction in a separate file system.

In accordance with still yet another aspect of the present invention, there is provided a data processing server for searching transaction history data, including: a user interface for allowing a user to input a search query for the transaction history data; and a processor for searching or supporting to search index data related to a transaction in a database by using a value of a search key if the search query for the transaction history data is inputted and trace data related to the transaction in a file system by referring to a start time and an end time of the transaction included in the index data.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing exemplarily illustrating a configuration of a transaction history data processing system in accordance with one example embodiment of the present invention.

FIG. 2 is a reference diagram to explain a method for storing and searching long-term transaction data.

FIG. 3 is a drawing representing examples of points at which transaction data and trace data are created.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to the present invention to be carried out easily, the example embodiments of the present invention by referring to attached diagrams will be explained in detail as follows:

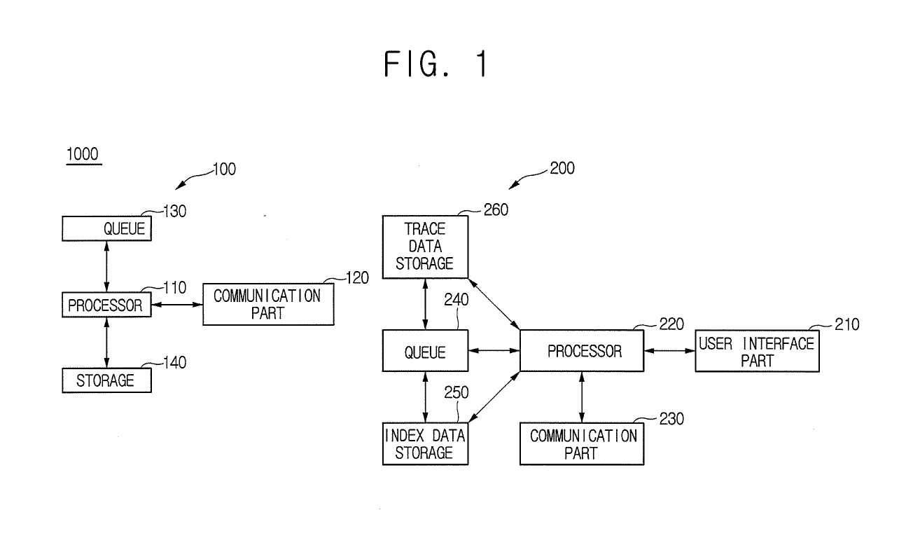

FIG. 1 is a drawing exemplarily illustrating a configuration of a transaction history data processing system in accordance with one example embodiment of the present invention.

By referring to FIG. 1, a transaction history data processing system 1000 in accordance with one example embodiment of the present invention includes a business processing server 100 and a data processing server 200.

More specifically, the business processing server 100 creates and stores history data in itself or transmits them to the data processing server 200. Below explained will be configurations and operations of the business processing server 100 and the data processing server 200.

The business processing server 100 may include a processor 110, a communication part 120, a queue 130, and a storage 140.

The processor 110 may control the whole operation of the business processing server 100. In particular, the processor 110 may create or support to create index data regarding a start of a transaction if the transaction starts. The transaction may start by a client's request. If the transaction starts, at least one of individual services of the transaction may be processed until the transaction ends. The individual services may be processed in connection with one or more other devices. For example, a service of transmitting a query to an external database and receiving a result of the query may be processed. At the time, the processor 110 may create or support to create trace data related to processing the individual services. The trace data may be divided by a certain unit of time and thereby created in a file format. In addition, if the transaction ends, the processor 110 may create or support to create index data regarding an end of the transaction.

The index data may include at least some data of GUID (i.e., a unique ID of a transaction), BIZTXID (i.e., a unique ID of a business transaction), ERRORCODE (i.e., an error code), INBOUNDENDPOINTID (i.e., a unique ID of a network engine that generates the transaction), STATE (i.e., a current status of a progress of the transaction), STARTTIME (i.e., a start time of the transaction), and ENDTIME (i.e., an end time of the transaction).

The trace data may include at least some data of HEADER (i.e., an identifier of trace data), LENGTH (i.e., full length of the history data), GUID (i.e., a unique ID of the transaction), SEQ (i.e., a sequence of history by point generated in the transaction), DATETIME (i.e., a creation time of the history data), POINT (i.e., information showing at which point the history was created), TARGETID (i.e., a unique ID of a target service), SYSID (i.e., a unique ID of a service caller), TYPE (i.e., a type of the service caller), and MESSAGE (i.e., an inputted or outputted message).

The communication part 120 may perform communications with an external device or among internal modules. In particular, the communication part 120 may store or support to store the index data regarding the start of the transaction and the index data regarding the end of the transaction in a database and may store or support to store the trace data related to processing the individual services of the transaction in a file system separate from the database. The database and the file system may be configured in the business processing server 100, but, in another case, the database and the file system may be managed by the data processing server 200. For example, the communication part 120 may allow the data processing server 200 to store the index data in the database or the trace data in the file system by transmitting them to the data processing server 200.

The queue 130 may be a storage with a data structure for preferentially storing index data or trace data if the index data or the trace data are created. If index data regarding the start of the transaction, index data regarding the end of the transaction, or trace data related to processing the individual services of the transaction are created, the processor 110 may preferentially store them in the queue 130. The stored history data (i.e., the index data and/or the trace data) may be read in the queue 130 and then transmitted to the data processing server 200. The queue 130 may minimize a degradation caused by multiple lock contentions during courses of inputting data by using index variables guaranteeing atomicity.

On the other hand, if there is no failure in data transmission to the data processing server 200, the communication part 120 allows the data processing server 200 to store the index data regarding the start of the transaction and the index data regarding the end of the transaction in the database, or the trace data related to processing the individual services of the transaction in the file system by transmitting them to the data processing server 200.

On the contrary, if there is a failure in data transmission to the data processing server 200, the processor 110 may store the index data regarding the start of the transaction, the index data regarding the end of the transaction, or the trace data related to processing the individual services of the transaction in its storage 140. The storage 140 is equipped separately from the queue 130 aforementioned. If the failure in the data transmission to the data processing server 200 is restored, the communication part 120 may read the data stored in the storage 140 and then transmit them to the data processing server 200.

Even if there is no failure in the data transmission to the data processing server 200, in case the index data or the trace data are stored in the storage 140, the processor 110 may store newly created index data or newly created trace data in the storage 140 without transmitting them to the data processing server 200.

To minimize data loss arising from the failure in the data transmission, the data are removed from the queue 130 after the data are transmitted from the queue 130 to a queue 240 of the data processing server 200 or the data are stored in the storage 140.

The processor 110 performs a function of controlling the flow of data among the communication part 120, the queue 130, the storage 140, and other components. In short, the processor 110 controls the communication part 120, the queue 130, the storage 140 and other components to perform their respective unique functions by controlling the flow of data among the components of the business processing server 100.

The processor 110 may include a configuration of hardware including micro processing unit (MPU), central processing unit (CPU), cache memory, data bus, etc. Besides, it may further include a configuration of an operating system or software of applications which perform a specific purpose.

In FIG. 1 and the suggested example embodiment of the present invention, it was explained that there is one business processing server 100, but in accordance with another example embodiment of the present invention, there may be multiple business processing servers 100 and in the case, the respective business processing servers may create history data.

Below explained will be the configuration and operation of the data processing server 200 which stores and searches transaction history data.

By referring to FIG. 1 again, the data processing server 200 in accordance with one example embodiment of the present invention includes a user interface part 210, a processor 220, a communication part 230, the queue 240, an index data storage 250, and a trace data storage 260.

As explained above, the data processing server 200 receives the index data and the trace data from the business processing server 100 through the communication part 210. The data processing server 200 may receive the index data regarding the start of the transaction, the index data regarding the end of the transaction, or the trace data related to processing the individual services of the transaction and then insert them preferentially into the queue 240. Just as shown in the queue 130, the queue 240 may use index variables guaranteeing atomicity.

History data stored in the queue 240 may be stored in the trace data storage 260 or the index data storage 250 depending on the nature of the history data. As explained above, as the index data may be stored in a database, the index data storage 250 may function as the database. In addition, as the trace data may be stored in a file system, the trace data storage 260 may function as the file system.

The user interface 210 may allow a user to input a search query for transaction history data by providing the user with user interface.

The processor 220 may control a whole operation of the data processing server 200. In particular, if a search query for a specific transaction history data, i.e., history data regarding a specific transaction, is inputted, the processor 220 may search or support to search a specific index data related to the specific transaction in the index data storage 250 and a specific trace data related to the specific transaction in the trace data storage 260 by referring to a start time and an end time of the specific transaction included in the specific index data. More specifically, the processor 220 may search or support to search the specific index data related to the specific transaction where a specific value of a search key is included and the specific trace data related to the specific transaction corresponding to the start time and the end time of the specific transaction included in the specific index data. And, the processor 220 may search the specific trace data with a specific GUID in the file system within the start time and the end time of the specific transaction included in the specific index data.

For reference, it was explained in the aforementioned example embodiment that the business processing server 100 and the data processing server 200 are separate devices but they could be also implemented as one device.

Meanwhile, information on large transaction history data may be also managed more effectively by storing and managing so-called long-term transaction data whose transaction does not end within a specific time from a time at which the transaction starts in a separate file system.

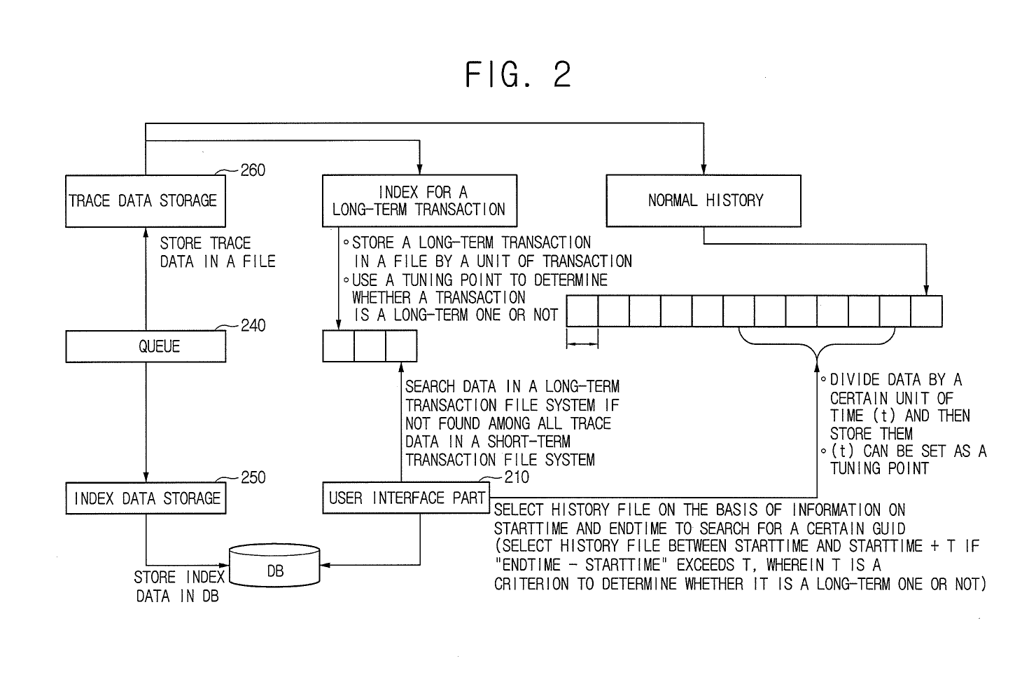

FIG. 2 is a reference diagram to explain a method for storing and searching long-term transaction data.

By referring to FIG. 2, if a certain transaction does not end within a certain time after the certain transaction starts, the trace data related to processing the individual services of the certain transaction may be stored as long-term transaction data in a separate file system. Herein, the long-term transaction data may be stored in one or more files by a unit of transaction based on a time at which the long-term transaction data is generated. For reference, whether a certain transaction is a long-term one or not is determined based on a tuning point. In case of the long-term transaction data, the certain transaction may be separately stored with being indicated as long-term one.

If a certain trace data related to an end of the certain transaction is not found from a start time (STARTTIME) of the certain transaction to a certain time, the processor 220 of the data processing server 200 may search corresponding history data in a separate file system (i.e., a long-term transaction file system) based on the start time of the certain transaction. In short, if the certain trace data related to the end of the certain transaction is not found in a normal history file, the long-term transaction file system may be accessed and searched.

In another case, if a difference between the end time (ENDTIME) and the start time (STARTTIME) of the certain transaction included in the index data in the file system exceeds the prescribed time (T), the processor 220 may also search or support to search the certain trace data related to the certain transaction among all trace data between the start time (STARTTIME) of the certain transaction and a time point when the prescribed time has passed from the start time of the certain transaction (STARTTIME+T). If the certain trace data related to the end of the certain transaction is not found, the certain trace data may be retrieved from a database in which the long-term transaction data are stored.

Below explained will be examples of points at which transaction data and trace data are created and examples of transaction data and trace data in the present invention.

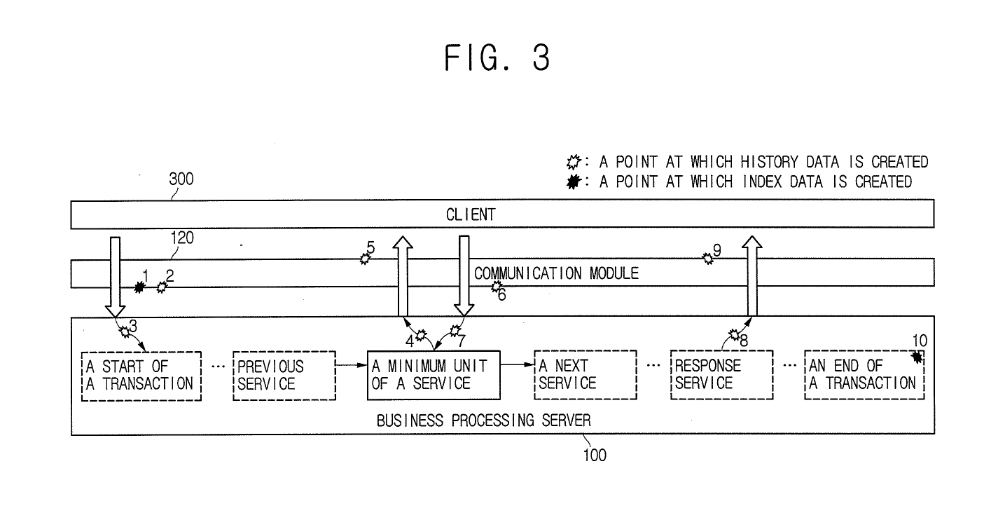

FIG. 3 is a drawing representing examples of points at which transaction data and trace data are created.

By referring to FIG. 3, history data 1 representing a start of a transaction and history data 10 representing an end of the transaction may be created and at least one trace data may be created between the start and the end of the transaction. As illustrated in FIG. 3, the trace data may include one of history data 2 of a service call for starting the transaction, history data 3 of a received request for starting the services from the communication part 120 of the business processing server 100, history data 4 of a request for transmitting a message from the business processing server 100 through the communication part 120, history data 5 of the message transmitted to a client from the communication part 120, history data 6 of a response message sent to the business processing server 100 from the communication part 120, history data 7 of the response message received by the business processing server 100, history data 8 of a call for transmitting another response message to the client from the business processing server 100, and history data 9 of the response message transmitted to the client from the communication part 120.

As explained above, the processor 220 performs a function of controlling the flow of data among the user interface 210, the communication part 230, the queue 240, the index data storage 250, the trace data storage 260, and other components. In short, the processor 220 controls the user interface 210, the communication part 230, the queue 240, the index data storage 250, the trace data storage 260 and other components to perform their respective unique functions by controlling the flow of data among the respective components of the data processing device 200.

The processor 220 may include a configuration of hardware including micro processing unit (MPU), central processing unit (CPU), cache memory, data bus, etc. Besides, it may further include a configuration of an operating system or software of applications which perform a specific purpose.

The present invention has following effects:

In accordance with the present invention, a large transaction history management system capable of minimizing a difference between a point at which transaction history data are generated and a point at which the transaction history data are possible to search may be provided by storing and managing information on large transaction history more effectively.

Besides, in accordance with the present invention, a large transaction history management system capable of minimizing a difference between a point at which the transaction history data are generated and a point at which the transaction history data are possible to search may be provided by separately creating, storing, and managing history data to be used as index data and history data (i.e., trace data) by point at which an actual transaction occurs.

In accordance with the present invention, if there is a data transmission failure, the history data are stored temporarily in a storage of the business processing server and then if the failure is restored, the data may be transmitted to the data processing server in order to prevent data loss.

As well, in accordance with the present invention, a large transaction history management system capable of storing and searching information on large transaction history more effectively and quickly may be provided by storing and managing long-term transaction data whose transaction does not end within a specific time from a time at which the transaction starts in a separate file system.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for storing transaction history data, comprising steps of:
(a) a business processing server creating or supporting to create index data regarding a start of a transaction if the transaction starts;
(b) the business processing server creating or supporting to create trace data related to processing individual services of the transaction; and
(c) the business processing server creating or supporting to create index data regarding an end of the transaction if the transaction ends;
wherein the business processing server stores or supports to store the index data regarding the start of the transaction and the index data regarding the end of the transaction in a database and the trace data related to processing the individual services of the transaction in a separate file system.

2. The method of claim 1, wherein, if there is no failure in data transmission, the business processing server allow a data processing server to store the index data regarding the start of the transaction and the index data regarding the end of the transaction in the database or the trace data related to processing the individual services of the transaction in the file system by transmitting them to the data processing server.

3. The method of claim 1, wherein, if there is failure in data transmission, the business processing server stores the index data regarding the start of the transaction, the index data regarding the end of the transaction, or the trace data related to processing the individual services of the transaction in its own storage and then if the failure in the data transmission is restored, the data stored in its own storage are read and transmitted to a data processing server.

4. The method of claim 3, wherein, in case the index data or the trace data are stored in the storage, even if there is no failure in the data transmission, the business processing server stores newly created index data or newly created trace data in the storage instead of transmitting the data to the data processing server.

5. The method of claim 1, wherein, if the index data regarding the start of the transaction, the index data regarding the end of the transaction, or the trace data related to processing the individual services of the transaction are created, the business processing server preferentially stores the data in a queue.

6. The method of claim 5, wherein the queue uses one or more index variables guaranteeing atomicity.

7. The method of claim 1, wherein, if the index data regarding the start of the transaction, the index data regarding the end of the transaction, or the trace data related to processing the individual services of the transaction are transmitted to a data processing server in order to be stored in the database or the file system, the transmitted data are preferentially stored in a queue.

8. The method of claim 7, wherein the queue uses one or more index variables guaranteeing atomicity.

9. The method of claim 1, wherein the trace data are divided by a certain unit of time and then stored in a file format.

10. The method of claim 1, wherein, if the transaction does not end within a specific time from a time at which the transaction starts, the business processing server stores or supports to store the trace data related to processing the individual services of the transaction as long-term transaction data in a separate file system.

11. The method of claim 1, wherein the trace data include at least one of history data of a service call for starting the transaction by a communication module of the business processing server, history data of a received request for starting the services from the communication module, history data of a request for transmitting a message from the business processing server through the communication module, history data of the message transmitted to a client through the communication module, history data of a response message sent to the business processing server through the communication module, history data of the response message received by the business processing server, history data of a call for transmitting another response message to the client by the business processing server, and history data of the response message transmitted to the client through the communication module.

12. A method for searching transaction history data, comprising steps of:
(a) a data processing server searching or supporting to search index data related to a transaction in a database by using a value of a search key if a search query for the transaction history data is inputted; and
(b) the data processing server searching or supporting to search trace data related to the transaction in a file system by referring to a start time and an end time of the transaction included in the index data.

13. The method for claim 12, wherein, at the step of (b), the data processing server searches the trace data with a specified GUID in the file system within the start time and the end time of the transaction included in the index data.

14. The method for claim 12, wherein, at the step of (b), the data processing server searches history data in a separate file based on the start time of the transaction if trace data related to the end of the transaction is not found among all trace data related to the transaction in the file system from the start time of the transaction included in the index data to a time point when a certain time has passed from the start time.

15. The method for claim 12, wherein, at the step of (b), the data processing server searches or supports to search the trace data related to the transaction among all trace data between the start time of the transaction and a time point when a prescribed time has passed from the start time of the transaction if difference between the end time and the start time of the transaction included in the index data in the file system exceeds the prescribed time.

16. A business processing server for storing transaction history data, comprising:
a processor for creating or supporting to create index data regarding a start of a transaction if the transaction starts, trace data related to processing individual services of the transaction, and index data regarding an end of the transaction if the transaction ends; and
a communication part for storing or supporting to store the index data regarding the start of the transaction and the index data regarding the end of the transaction in a database and the trace data related to processing the individual services of the transaction in a separate file system.

17. The business processing server of claim 16, wherein, if there is no data failure in data transmission, the communication part allow a data processing server to store the index data regarding the start of the transaction and the index data regarding the end of the transaction in the database or the trace data related to processing the individual services of the transaction in the file system by transmitting them to the data processing server.

18. The business processing server of claim 16, further comprising a storage, wherein, if there is failure in data transmission, the processor stores the index data regarding the start of the transaction, the index data regarding the end of the transaction, or the trace data related to processing the individual services of the transaction in the storage; and then if the failure in the data transmission is restored, the communication part reads the data stored in the storage and transmits them to a data processing server.

19. The business processing server of claim 18, wherein, in case the index data or the trace data are stored in the storage, even if there is no failure in the data transmission, the processor stores newly created index data or newly created trace data in the storage instead of transmitting the data to the data processing server.

20. The business processing server of claim 16, wherein, if the index data regarding the start of the transaction, the index data regarding the end of the transaction, or the trace data related to processing the individual services of the transaction are created, the processor preferentially stores them in a queue.

21. The business processing server of claim 20, wherein the queue uses one or more index variables guaranteeing atomicity.

22. The business processing server of claim 16, wherein, if the index data regarding the start of the transaction, the index data regarding the end of the transaction, or the trace data related to processing the individual services of the transaction are transmitted to a data processing server in order to be stored in the database or the file system, the transmitted data are preferentially stored in a queue.

23. The business processing server of claim 22, wherein the queue uses one or more index variables guaranteeing atomicity.

24. The business processing server of claim 16, wherein the trace data are divided by a certain unit of time and then stored in a file format.

25. The business processing server of claim 16, wherein, if the transaction does not end within a specific time from a time at which the transaction starts, the communication part stores or supports to store the trace data related to processing the individual services of the transaction as long-term transaction data in a separate file system.

26. The business processing server of claim 16, wherein the trace data include at least one of history data of a service call for starting the transaction by the communication part, history data of a received request for starting the services from the communication part, history data of a request for transmitting a message from the business processing server through the communication part, history data of the message transmitted to a client through the communication part, history data of a response message sent to the business processing server through the communication part, history data of the response message received by the business processing server, history data of a call for transmitting another response message to the client by the business processing server, and history data of the response message transmitted to the client through the communication part.

27. A data processing server for searching transaction history data, comprising:
a user interface for allowing a user to input a search query for the transaction history data; and
a processor for searching or supporting to search index data related to a transaction in a database by using a value of a search key if the search query for the transaction history data is inputted and trace data related to the transaction in a file system by referring to a start time and an end time of the transaction included in the index data.

28. The server of claim 27, wherein the processor searches the trace data with a specified GUID in the file system within the start time and the end time of the transaction included in the index data.

29. The server of claim 27, wherein the processor searches history data in a separate file based on the start time of the transaction if the trace data related to the end of the transaction is not found among all trace data related to the transaction in the file system from the start time of the transaction included in the index data to a time point when a certain time has passed from the start time.

30. The server of claim 27, wherein the processor searches or supports to search the trace data related to the transaction among all trace data between the start time of the transaction and a time point when a prescribed time has passed from the start time of the transaction if difference between the end time and the start time of the transaction included in the index data in the file system exceeds the prescribed time.
